(19) United States
(12) Patent Application Publication
(10) Pub. No.: US 2011/0089900 A1
(43) Pub. Date: Apr. 21, 2011

(54) BATTERY PACK

(75) Inventor: Masaki Hogari, Fukushima (JP)

(73) Assignee: SONY CORPORATION, Tokyo (JP)

(21) Appl. No.: 12/898,811

(22) Filed: Oct. 6, 2010

(30) Foreign Application Priority Data
Oct. 15, 2009 (JP) P2009-237822

(51) Int. Cl. H02J 7/00

(52) U.S. Cl. 320/118

(57) ABSTRACT

A battery pack includes electric cells connected in series or in parallel between first and second lines, each of the electric cells having a battery cell, a control circuit which performs authentication processing, a communication block which is connected to the control circuit and superimposes a series binary data string on a battery output of the battery cell, and a switching element controlled by the control circuit. The control circuit generates its address. The control circuit of each electric cell transmits the series binary data string including the address to a main body via the communication block and the first and second lines for authentication on each electric cell. The switching element is turned on when the authentication is successful, and charging or discharging is performed. The switching element is turned off when the authentication is unsuccessful, and charging or discharging is banned.

### CROSS REFERENCES TO RELATED APPLICATIONS

The present application claims priority to Japanese Priority Patent Application JP 2009-237822 filed in the Japan Patent Office on Oct. 15, 2009, the entire content of which is hereby incorporated by reference.

### BACKGROUND

The present application relates to a battery pack applied to a secondary battery such as a cylindrical lithium-ion secondary battery.

In recent years, more and more electronic devices including mobile telephones and notebook-size personal computers have become cordless and portable, and thin, small, and lightweight portable electronic devices have been developed in quick succession. Moreover, electricity use has been increased due to the diversification of devices and functions of electric tools and in-vehicle devices (electric vehicles), and demand for a higher-capacity and lighter battery which is an energy source of these electronic devices has grown.

Therefore, as a secondary battery which meets the above demand, a lithium-ion secondary battery (hereinafter also referred to as a lithium-ion battery) which utilizes lithium ion doping and undoping has been proposed.

A lithium-ion battery has a positive electrode and a negative electrode. For example, the positive electrode is formed such that a positive-electrode active material layer using a lithium composite oxide such as LiCoO₂ or LiNiO₂ is formed on a positive-electrode charge collector. The negative electrode is formed of a negative-electrode active material layer using carbon material such as graphite or non-graphitizable carbon material which can dope and undope lithium. The negative-electrode active material layer is formed on a negative-electrode charge collector. The positive electrode and the negative electrode are laid one on top of another with a separator placed therebetween, and are bent or wound to form a cell element. Such cell element is housed in a metal can or a laminate film, for example, together with a nonaqueous electrolytic solution obtained by dissolving lithium salt in a nonprotic organic solvent, whereby a battery is formed.

The lithium-ion battery is so designed as to ensure sufficient safety under normal use conditions. For example, the lithium-ion battery is provided with a positive temperature coefficient (PTC) element which limits a current when the temperature inside the battery increases and a safety valve which cuts electrical connection in the battery when the internal voltage increases.

Moreover, since the lithium-ion battery is sensitive to overcharge and overdischarge, the lithium-ion battery is usually formed as a battery pack into which a battery cell and a protection circuit are integrated. The protection circuit has overcharge protective function, overdischarge protective function, and overcurrent protective function. These protective functions will be described briefly.

The overcharge protective function will be described. When the lithium-ion battery is charged, the battery voltage keeps increasing even after the lithium-ion battery is fully charged. Such overcharge state may be dangerous for the lithium-ion battery. Therefore, it is necessary to perform charging with a constant current at a constant voltage in a state in which the charge control voltage is equal to or less than the rating of the battery (for example, 4.2 V). However, there is a danger that overcharge occurs due to a breakdown in a charger or the use of a charger for a different model. When the battery is overcharged and the battery voltage becomes equal to or more than a certain voltage value, the protection circuit turns off a charge control FET (field effect transistor) and interrupts the charging current. This function is the overcharge protective function.

The overdischarge protective function will be described. When the battery is discharged below a rated discharge cutoff voltage and is brought into an overdischarge state in which the battery voltage is 2 to 1.5 V or less, for example, the battery may break down. When the battery is discharged and the battery voltage becomes equal to or less than a certain voltage value, the protection circuit turns off a discharge control FET and interrupts the discharging current. This function is the overdischarge protective function.

The overcurrent protective function will be described. When a short circuit occurs between the positive and negative terminals of the battery, there is a danger that a high current flows and abnormal heat is generated. When a discharging current of equal to or more than a certain current value flows, the protection circuit turns off the discharge control FET and interrupts the discharging current. This function is the overcurrent protective function. The overdischarge protective function and the overcurrent protective function are similar functions in that the discharging current is interrupted.

Such a lithium-ion battery has to be charged by a charging apparatus manufactured by an authorized manufacturer so that the battery is used safely and such a problem as a decrease in a battery life is prevented. For example, some unauthorized charging apparatuses do not meet the proper specifications, and, if charging is performed using such a charging apparatus, there is a possibility that the battery is overcharged. On the other hand, if an electronic device (referred to below as an application apparatus) which uses the battery pack as a power source is not an authorized device, there is a possibility that the discharging current becomes too high. Thus, it is desired that the application apparatus is an authorized apparatus.

Japanese Patent No. 3833679 describes a charge control method in which a charging current is interrupted when authentication is unsuccessful after mutual authentication is performed between a battery pack and a charging apparatus. Furthermore, Japanese Unexamined Patent Application Publication No. 11-164548 describes that wireless communication is performed between a battery pack and a charging apparatus, information of the battery pack is obtained by the charging apparatus, and charging is performed based on the information thus obtained.

### SUMMARY

According to the charge control method described in Japanese Patent No. 3833679, a microcomputer in the battery pack and a microcomputer in the charging apparatus perform two-way communication via a dedicated communication line. As described above, when a communication terminal which differs from the power supply terminal is provided, a manufacturer of an unauthorized battery pack or charging apparatus immediately finds out that, based on the presence of the communication terminal, authentication is performed. Therefore, there is a high possibility that a battery pack is produced including an unauthorized battery cell provided with a duplicated electronic circuit for authentication by analyzing the microcomputer controlled by the communication terminal. Furthermore, providing the communication terminal results in an increase in the number of components and costs.

The configuration described in Japanese Unexamined Patent Application Publication No. 11-164548 that performs wireless communication, undesirably increases costs due to the wireless communication. Furthermore, there is a possibility that a unit for wireless communication is duplicated.

In addition, a battery pack often includes a plurality of electric cells, and it is desirable to perform authentication as to whether each of the electric cells is an authorized product or not. With the configuration in which one identification resistor is connected to the battery pack, it is difficult to deal with a situation in which part of the electric cells is replaced with an unauthorized product. Furthermore, in the battery pack using a plurality of battery cells, wiring is provided between the terminals of each battery and the detecting section in order to detect the battery voltage of each battery cell. This complicates the wiring in the battery pack.

It is desirable to provide a battery pack without providing a communication terminal for authentication that was included in a battery pack performing the above-described authentication, when a plurality of battery cells are used.

According to an embodiment, there is provided a battery pack including a plurality of electric cells connected in series or in parallel between first and second lines, each of the electric cells having a battery cell, a control circuit which performs authentication processing, a communication block which is connected to the control circuit and superimposes a series binary data string on a battery output of the battery cell, and a switching element controlled by the control circuit. The control circuit generates an address thereof. The control circuit of each electric cell transmits the series binary data string including the address to a main body via the communication block and the first and second lines and performs authentication on each electric cell. The switching element is turned on, when the authentication is successful, and charging or discharging is performed, and the switching element is turned off, when the authentication is unsuccessful, and charging or discharging is banned.

Preferably, the control circuit of the electric cell further controls a protective function for overcharge and overdischarge of the battery cell.

According to an embodiment, each electric cell communicates with a main body via two lines transmitting a battery voltage. This makes it possible to simplify a configuration and reduce costs as compared to a configuration in which separate communication terminals and communication lines are used. The main body can perform communication with a plurality of electric cells individually, and determine whether each electric cell is an authorized product or not.

Additional features and advantages are described herein, and will be apparent from the following Detailed Description and the figures.

### BRIEF DESCRIPTION OF THE FIGURES

FIG. 1 is a sectional view of an example of a cylindrical lithium-ion battery to which an embodiment can be applied;

FIG. 2 is a perspective view of components of a safety device in the cylindrical lithium-ion battery to which the embodiment can be applied;

FIG. 3 is a sectional view of a positive-electrode section of a cylindrical lithium-ion battery according to the embodiment;

FIG. 4 is a plan view of the positive-electrode section of the cylindrical lithium-ion battery according to the embodiment;

FIG. 5 is a connection diagram illustrating the configuration of a protection and authentication circuit according to the embodiment;

FIG. 6 is a connection diagram used for describing a reception operation of a communication block in the protection and authentication circuit;

FIGS. 7A to 7C are waveform diagrams used for describing a reception operation of the communication block in the protection and authentication circuit;

FIG. 8 is a connection diagram used for describing a transmission operation of the communication block in the protection and authentication circuit;

FIG. 9 is a flow chart used for describing a control operation of the embodiment;

FIG. 10 is a flow chart used for describing a control operation at the time of charging in the embodiment;

FIG. 11 is a flow chart used for describing a control operation at the time of discharging in the embodiment;

FIG. 12 is a block diagram illustrating the configuration of an embodiment;

FIGS. 13A and 13B are waveform diagrams used for describing a transmission signal of the embodiment;

FIG. 14 is a block diagram illustrating the configuration of a modified example of the embodiment; and

FIG. 15 is a flow chart illustrating control processing of the embodiment.

### DETAILED DESCRIPTION

An embodiment of the present application will be described in detail hereinbelow with reference to the drawings.

1. Example of Common Lithium-Ion Secondary Battery

2. Embodiment

3. Modified Example

It is to be understood that an embodiment described below is a preferred specific example of the present application and includes various preferred technical limitations. However, the scope of the present application is not limited to the embodiment unless stated that it is limited thereto in the following description.

### 1. Example of Common Lithium-Ion Secondary Battery

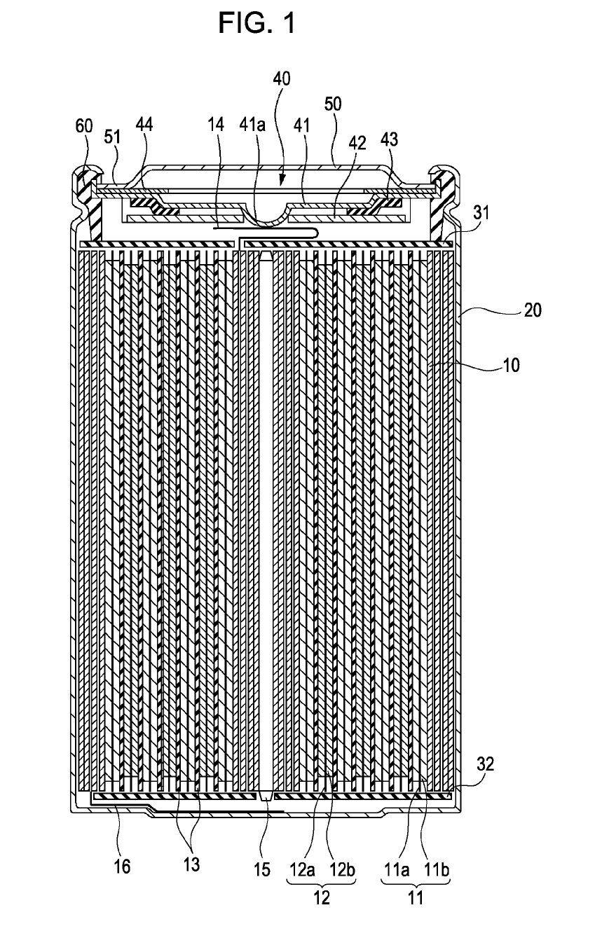

An example of a common cylindrical lithium-ion battery which can be applied to a battery cell according to an embodiment will be described with reference to FIG. 1. A power-generating element 10 is housed in a cylindrical battery housing 20.

The power-generating element 10 is formed of a strip-shaped positive electrode 11 and a strip-shaped negative electrode 12 which are wound around a center pin 15 with a separator 13 placed therebetween, the separator 13 impregnated with an electrolytic solution which is a liquid electrolyte. The positive electrode 11 has a structure in which a positive-electrode mixture layer 11b including positive-electrode material that can perform lithium (Li) doping and undoping is provided, as positive-electrode active material, on both sides (or one side) of a positive-electrode charge collector 11a formed of aluminum foil, for example. A positive-electrode lead 14 made of aluminum or the like is attached to the positive-electrode charge collector 11a and is drawn out of the power-generating element 10.

The negative electrode 12 has a structure in which a negative-electrode mixture layer 12b including negative-electrode material that can perform lithium doping and undoping is provided, as negative electrode active material, on both sides (or one side) of a negative-electrode charge collector 12a formed of copper foil, for example. A negative-electrode lead 16 made of copper is attached to the negative-electrode charge collector 12a and is drawn out of the power-generating element 10.

The separator 13 is formed of a porous film made of synthetic resin or ceramic, for example. The electrolytic solution includes, for example, a solvent such as an organic solvent and lithium salt which is electrolytic salt dissolved in this solvent. A pair of insulating plates 31 and 32 is disposed on end faces of the power-generating element 10 formed by winding the positive electrode 11 and the negative electrode 12 around the center pin 15.

The battery housing 20 is made of, for example, nickel (Ni)-plated iron (Fe) or stainless steel. The battery housing 20 is closed on one end face (a negative electrode) side and is opened on the other end face (a positive electrode) side. The battery housing 20 is connected to the negative electrode, and is made to function as a negative-electrode terminal. In addition, a safety mechanism 40 and a battery lid 50 are attached by being squeezed into the open end face of the battery housing 20 with a gasket 60 placed between the battery housing 20 and the safety mechanism 40 and battery lid 50, whereby the battery housing 20 is made airtight.

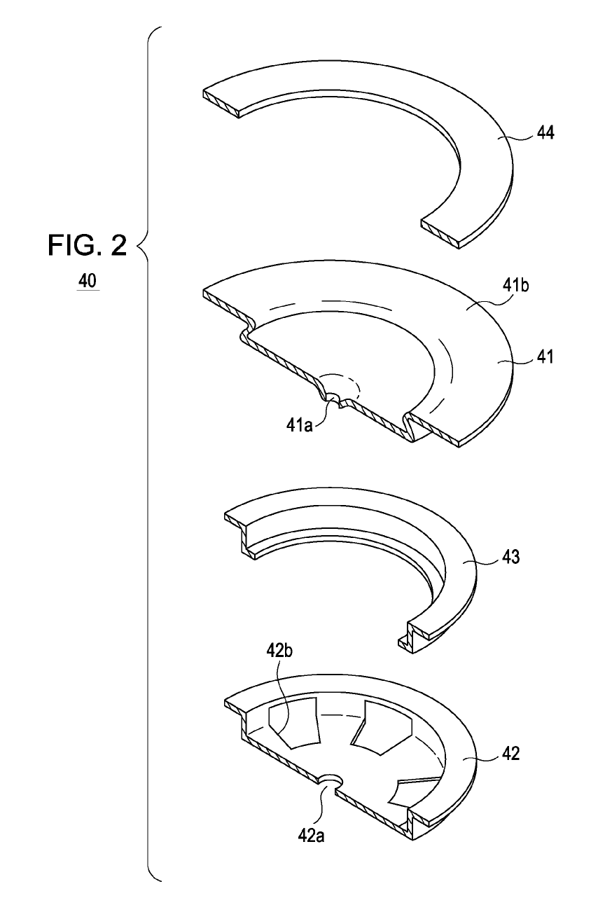

An example of the safety mechanism 40 will be described with reference to FIG. 2 which is a perspective view of the half of the safety mechanism 40. A safety valve 41 made of metal material such as aluminum is fitted into a supporting holder 42 made of metal material such as aluminum with an insulating holder 43 placed between the safety valve 41 and supporting holder 42. The safety valve 41 has, at the center of the bottom thereof, a projection 41a projecting toward the power-generating element 10, and the projection 41a is inserted into an opening 42a formed at the center of the bottom of the supporting holder 42. On the periphery of the safety valve 41, a flange portion 41b is provided to ensure electrical connection between the battery lid 50 and the safety valve 41 through a PTC element 44 placed between the flange portion 41b and the battery lid 50. A plurality of openings 42b are formed in the side wall of the supporting holder 42 as air holes. The positive-electrode lead 14 is welded to the projection 41a of the safety valve 41.

In the safety mechanism 40, when the internal pressure of the battery increases due to an internal short-circuit, heat applied to the outside, or the like, and reaches a predetermined value, the increased internal pressure is carried to the safety valve 41 via the openings 42b of the supporting holder 42. The safety valve 41 is deformed toward the battery lid 50 by the internal pressure. As a result, the battery internal pressure is alleviated and the electrical connection between the safety valve 41 and the positive-electrode lead 14 is interrupted, whereby the electrical connection between the battery lid 50 and the power-generating element 10 is interrupted.

The battery lid 50 functions as a positive-electrode terminal of the battery. As is the case with the battery housing 20, for example, the battery lid 50 is made of nickel-plated stainless steel, has a flange portion 51 on the periphery thereof, and has a plurality of notches in an upper portion thereof. The flange portion 51 of the battery lid 50 is electrically connected to the flange portion 41b of the safety valve 41 via the PTC element 44 placed between the flange portion 51 and the flange portion 41b. The resistance value of the PTC element 44 increases when the temperature increases, whereby the PTC element 44 prevents abnormal heat generation caused by a high current.

The secondary battery described above is produced as follows, for example.

First, positive-electrode material which can perform lithium doping and undoping, a conductive agent, and a bonding agent are mixed together to prepare a positive-electrode mixture, and this positive-electrode mixture is dispersed in a mixed solvent to obtain positive-electrode mixture slurry. Next, the positive-electrode mixture slurry is applied to the positive-electrode charge collector 11a and is dried, and is then subjected to compression molding to form the positive-electrode mixture layer 11b. In this way, the positive electrode 11 is formed. Subsequently, the positive-electrode lead 14 is connected to the positive-electrode charge collector 11a by ultrasonic welding, spot welding, or the like.

Negative-electrode material which can perform lithium doping and undoping and a bonding agent are mixed together to prepare a negative-electrode mixture, and this negative-electrode mixture is dispersed in a mixed solvent to obtain negative-electrode mixture slurry. Next, the negative-electrode mixture slurry is applied to the negative-electrode charge collector 12a and is dried, and is then subjected to compression molding to form the negative-electrode mixture layer 12b. In this way, the negative electrode 12 is formed. Then, the negative-electrode lead 16 is connected to the negative-electrode charge collector 12a by ultrasonic welding, spot welding, or the like.

In addition, the positive electrode 11 and the negative electrode 12 are wound many times with the separator 13 placed between the positive electrode 11 and the negative electrode 12, whereby a wound electrode body is obtained. Then, the wound electrode body is sandwiched between the pair of insulating plates 31 and 32, and is housed in the battery housing 20. Subsequently, the positive-electrode lead 14 is welded to the safety valve 41 of the safety mechanism 40, and the negative-electrode lead 16 is welded to the battery housing 20.

Moreover, an electrolytic solution is prepared by dissolving electrolytic salt in a solvent. Subsequently, the electrolytic solution is injected into the battery housing 20, and the separator 13 is impregnated with the electrolytic solution. Thereafter, the safety mechanism 40 and the battery lid 50 are fixed to the opening of the battery housing 20 by being squeezed into the opening with the gasket 60 placed between the battery housing 20 and the safety mechanism 40 and battery lid 50. In this way, the lithium-ion battery is completed. Although not described in the above description, in actuality, a resin ring washer is fitted to the battery lid 50, and the battery is fully covered by a resin tube.

### 2. Embodiment

Structure on the Positive Electrode Side

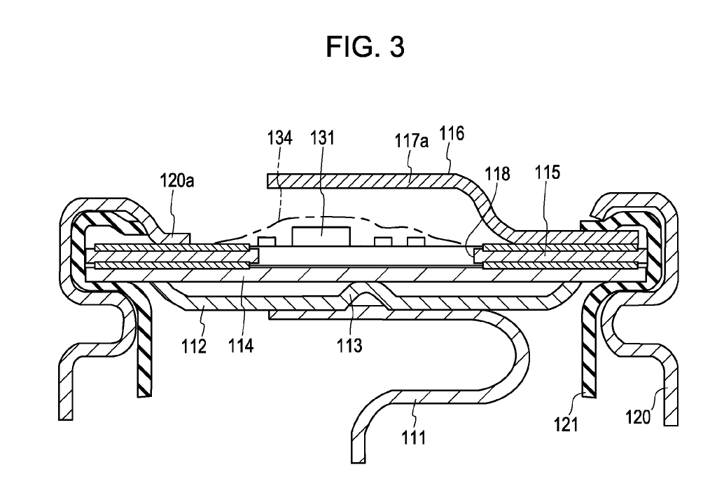

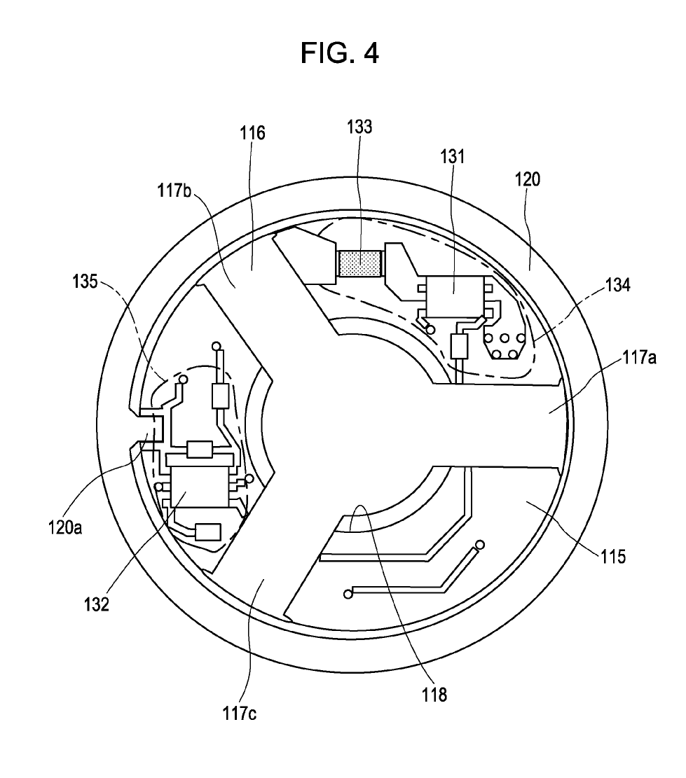

When the embodiment is applied to the lithium-ion secondary battery described above, the parts related to the embodiment are formed on the positive electrode side as shown in FIGS. 3 and 4. The power-generating element and other components are similar to those of the common cylindrical lithium-ion battery which has been described with reference to FIG. 1.

The safety device includes a disk 112 made of aluminum or other metal materials, a plate-like safety valve 114 made of aluminum or other metal materials, and other parts. The safety valve 114 has a thin portion to function as a cleavage valve. A positive-electrode lead 111 attached to the positive-electrode charge collector is welded to the disk 112. The disk 112 has a projection 113 formed at the center thereof as an interrupting section. A plurality of openings for ventilation are formed in the disk 112. The projection 113 is brought into contact with or is welded to the safety valve 114 placed above the projection 113. Other portions than the projection 113 of the disk 112 and the safety valve 114 are insulated by a disk holder (not shown) which is a ring-shaped insulator.

In the structure of FIG. 1, the PTC element 44 is placed between the safety valve 41 and the battery lid 50. In this embodiment, as shown in FIG. 3, a printed wiring board 115 is placed between the safety valve 41 and the battery lid 50. Therefore, it is preferable that the thickness of the printed wiring board 115 be almost the same as the PTC element 44. The printed wiring board 115 is a ring-shaped board having an opening at the center thereof, and a wiring pattern can be formed on both sides thereof.

On a lower face of the printed wiring board 115, a pattern which can be electrically connected to the safety valve 114 is formed. Since a relatively high current flows through this pattern, it is preferable that the pattern should make a plane contact with the safety valve 114 in a large area. For example, a ring-shaped conductive pattern is formed. The conductive pattern and a predetermined part of the conductive pattern formed on an upper face of the printed wiring board 115 are electrically connected via a through hole or the like.

A battery housing 120 is connected to the negative-electrode charge collector of the power-generating element, and functions as a negative-electrode terminal. The safety valve 114, the printed wiring board 115, and the flange portion of the battery lid 116 are squeezed into the opening of the battery housing 120 with a gasket 121 placed between these parts and the battery housing 120, and the battery housing 120 is made airtight.

The battery lid 116 is integrally formed with three foot portions 117a, 117b, and 117c which stand from the flat flange portion toward the flat terminal surface located at the center. These foot portions 117a, 117b, and 117c are positioned at angular intervals of about 120°, and an opening is formed between the foot portions 117a, 117b, and 117c. Although not shown in the drawing, a resin ring washer is fit to the battery lid 116, and the battery is fully covered by a resin tube.

When gas is produced in the battery housing 120 and the internal pressure increases, the safety valve 114 is pushed upward through the opening in the disk 112 to alleviate the internal pressure, and the welded part between the projection 113 and the safety valve 114 falls off, whereby the electrical connection between the positive electrode side of the power-generating element and the battery lid 116 is interrupted. When the internal pressure further increases, the safety valve 114 is destroyed at the thin portion thereof, whereby the gas is released to the outside of the battery through the opening 118 formed at the center of the printed wiring board 115 and the openings between the foot portions 117a, 117b, and 117c of the battery lid 116.

On the printed wiring board 115, a protection and authentication circuit of the lithium-ion battery is formed. That is, a P-channel FET element 131 serving as a switching element that turns on/off a current path between the positive electrode side (the safety valve 114) of the power-generating element and the positive-electrode output terminal (the battery lid 116) of the battery cell is mounted on the printed wiring board 115. Furthermore, a control circuit IC (integrated circuit) 132 supplying a control signal to the FET element 131, a fuse 133 inserted in series to the above-described current path, and other circuit elements are mounted on the printed wiring board 115 to form the protection and authentication circuit.

The control circuit IC 132 includes a microcomputer, and has a protective function and an authentication function. The FET element 131 and the control circuit IC 132, which are relatively large components among the circuit components mounted on the printed wiring board 115, are disposed under the openings between the foot portions 117a, 117b, and 117c of the battery lid 116 such that the upper portions of the FET element 131 and the control circuit IC 132 do not hit the battery lid 116 (see FIG. 4).

The fuse 133 opens when a current of equal to or greater than a predetermined value flows or the temperature increases to or above a temperature of a predetermined value. One end of the fuse 133 is connected to the FET element 131, and the other end thereof is connected (for example, welded) to the flange portion of the battery lid 116 via the conductive pattern. The conductive pattern including the FET element 131 and the fuse 133 has a size (width or volume) to pass a charging current and a discharging current.

A coating material (indicated by an alternate long and short dashed line) 134 sealing an area near the FET element 131 and the fuse 133 which are main circuit components mounted on the printed wiring board 115 and a coating material (indicated by an alternate long and short dashed line) 135 sealing an area near the control circuit IC 132 are provided. Alternatively, the printed wiring board 115 may be fully coated.

A tab 120a formed as a projected part of the battery housing 120 is connected to the conductive pattern by welding or the like, the conductive pattern connected to the grounding-side terminal of the control circuit IC 132. The tab 120a may be a small tab because the current flowing through the control circuit IC 132 is small compared to the charging current or the discharging current.

Protection and Authentication Circuit

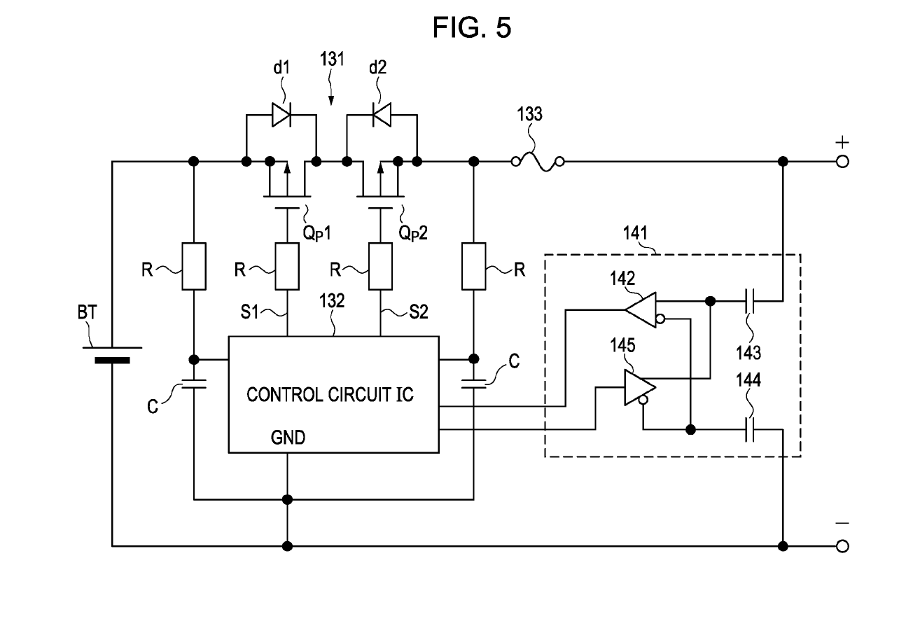

FIG. 5 illustrates a circuit configuration of a protection and authentication circuit of the embodiment. A positive electrode of a battery cell (the power-generating element) BT is connected to the source of a P-channel FET Q_{P}1, the drain of the FET Q_{P}1 and the drain of a P-channel FET Q_{P}2 are connected together, and the source of the FET Q_{P}2 is connected to a positive-side terminal (the battery lid 116) via the fuse 133. The FET Q_{P}1 is an FET for charge control, and a charge control signal S1 is supplied to the gate of the FET Q_{P}1 from the control circuit IC 132 via a resistor. The FET Q_{P}2 is an FET for discharge control, and a discharge control signal S2 is supplied to the gate of the FET Q_{P}2 from the control circuit IC 132 via a resistor. Parasitic diodes d1 and d2 are present between the drains and sources of the FETs.

The power supply terminal of the control circuit IC 132 is connected to the positive electrode side of the battery cell BT and the source of the FET Q_{P}2, and the grounding terminal (GND) of the control circuit 132 is connected to the negative electrode side of the battery cell BT. As mentioned above, this connection is established via the tab 120a formed integrally with the battery housing 120.

Further, a communication block 141 is connected to the control circuit IC 132. The communication block 141 performs two-way communication with a main body for authentication. The main body is a charging apparatus or an application apparatus using a battery pack as a power source, and includes a communication block having a structure similar to the communication block 141 in the battery pack. The battery pack and the main body are connected by two lines for transmitting positive and negative power supplies. A series binary data string is transferred via the two lines. Information which is output from the control circuit IC 132 and is sent to the main body includes a terminal voltage of the battery cell BT. RS-422, RS-485, or the like, defined by EIA (Electronic Industries Alliance) standards can be used as a transmission method. Details of the communication block 141 will be described later.

Protection Operation

When the voltage of the battery cell BT reaches an overcharge detection voltage or the voltage of the battery cell BT becomes equal to or less than an overdischarge detection voltage in the above-described protection and authentication circuit, the control circuit IC 132 transmits a control signal to the gate of the FET, thereby preventing overcharge and overdischarge. Here, when a lithium-ion battery is used, the overcharge detection voltage is set at 4.2 V±0.5 V, for example, and the overdischarge detection voltage is set at 2.4 V±0.1 V.

When the battery voltage reaches the overcharge detection voltage, the charge control FET Q_{P}1 is turned off by a charge control signal S1 from the control circuit IC 132 and the charging current does not flow. After the charge control FET Q_{P}1 is turned off, only discharging is possible via the parasitic diode d1 and the discharge control FET Q_{P}2.

When the battery voltage becomes the overdischarge detection voltage, the discharge control FET Q_{P}2 is turned off by a discharge control signal S2 from the control circuit IC 132 and the discharging current does not flow. After the discharge control FET Q_{P}2 is turned off, only charging is possible via the parasitic diode d2 and the charge control FET Q_{P}1. Furthermore, when a short circuit occurs between the positive and negative terminals of the battery, there is a danger that a high current flows and abnormal heat is generated. When a discharging current of equal to or more than a certain current value flows, the protection and authentication circuit interrupts the discharging current by turning off the discharge control FET Q_{P}2. In addition, when an abnormal condition occurs in which a high current flows due to a breakdown of the FET Q_{P}1 or Q_{P}2, the fuse 133 opens to ensure safety.

As described above, according to the embodiment, each battery includes the protection and authentication circuit, facilitating a plurality of batteries to be connected in series or in parallel. Further, there is no necessity to connect the protection and authentication circuit by drawing the lead to the outside of the battery. Since the P-channel FET is used to turn on/off the positive-side line, it is possible to dispose a protection and authentication circuit in a space above the positive-side safety device and eliminate a long lead for connection. Furthermore, by connecting the grounding terminal of the control circuit to a tab which is an extended part of the battery housing, it is possible to simplify the wiring pattern and prevent an increase in the number of components.

Communication Block

The communication block 141 includes a receiver 142 that receives a balanced differential input from a line and a generator 145 that sends a balanced differential output to the line. The series binary data string transmitted from the main body is supplied to the positive-side terminal (+) and the negative-side terminal (−), and is input to the receiver 142 as a differential input via capacitors 143 and 144. The series binary data string obtained from the receiver 142 is input to the control circuit IC 132.

The differential output of the generator 145 is supplied to the positive-side terminal (+) and the negative-side terminal (−) of the battery pack via the capacitors 143 and 144. To the generator 145, the series binary data string output from the control circuit IC 132 is supplied. The series binary data string output by the generator 145 is superimposed on the transmission line drawn out of each output terminal. Although not shown in the drawing, an opposite phase enable signal is supplied from the control circuit IC 132 to the receiver 142 and the generator 145, whereby an operating state (in which the receiver 142 and the generator 145 are connected to the transmission line) and a nonoperating state (in which the receiver 142 and the generator 145 are disconnected from the transmission line) of the receiver 142 and the generator 145 are switched.

Switching between the operating state and the nonoperating state in the communication block which is provided in the main body and has a similar configuration is opposite in phase with respect to the switching operation in the battery pack. That is, when data is transmitted from the main body to the battery pack, the generator of the main body and the receiver 142 of the battery pack are connected to the positive-side terminal and the negative-side terminal. Conversely, when data is transmitted from the battery pack to the main body, the generator 145 of the battery pack and the receiver of the main body are connected to the positive-side terminal and the negative-side terminal.

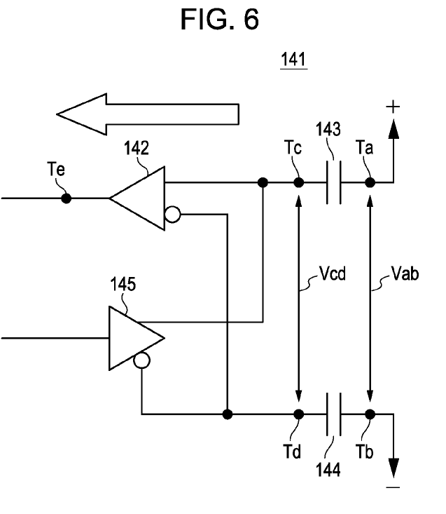

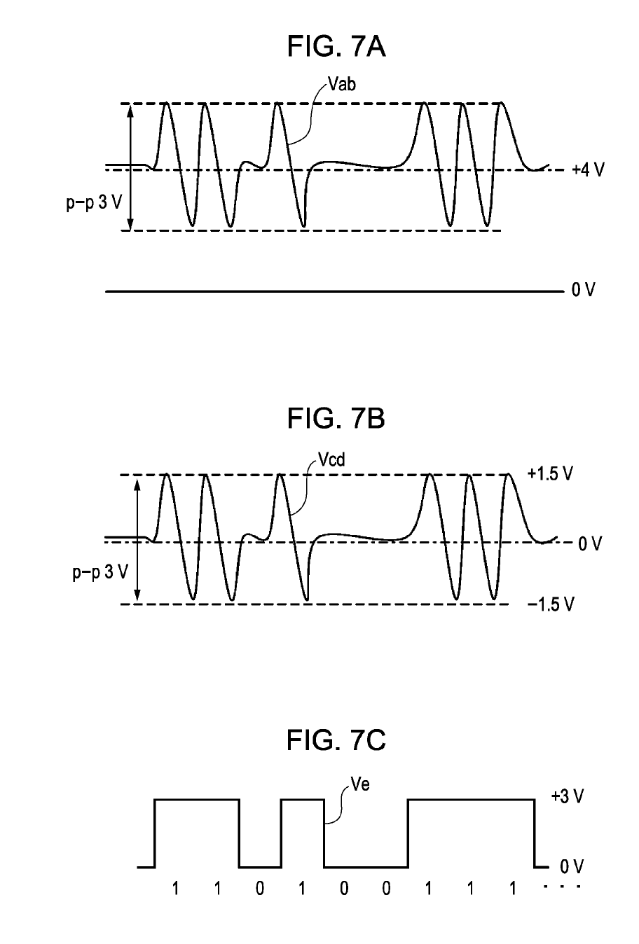

With reference to FIG. 6, a data reception operation in which the receiver 142 is in an operating state will be described. As shown in FIG. 7A, a signal voltage Vab having a voltage of the battery cell BT, for example, +4V as a bias and an amplitude whose p-p (peak to peak) is 3 V is supplied between the positive-side terminal (Ta) and the negative-side terminal (Tb). As a result of passing through the capacitors 143 and 144, a voltage Vcd between the terminals Tc and Td has a signal waveform (FIG. 7B) from which the bias is cut, the signal waveform having 0 V at the center.

The signal waveform shown in FIG. 7B is input to the receiver 142, and the receiver 142 outputs a series binary data string Ve (FIG. 7C) to the output terminal (Te) in accordance with whether the signal waveform is positive or negative. A waveform of a series binary data string when the power-supply voltage of the receiver 142 is +3 V is shown. The series binary data string Ve output from the receiver 142 is supplied to the control circuit IC 132.

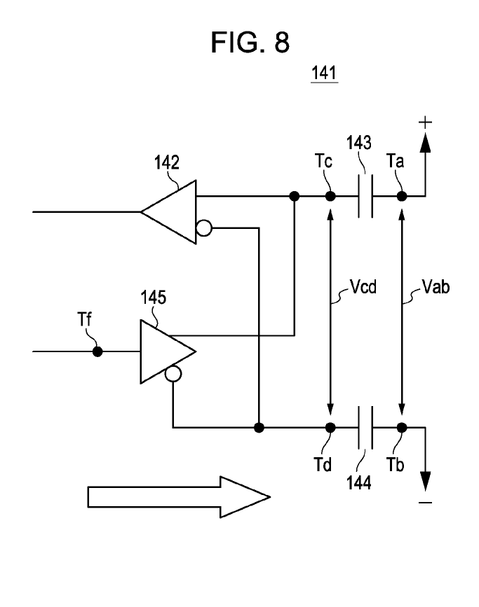

In a data transmission operation in which the generator 145 is in an operating state, processing opposite to the above-described data reception operation is performed. To an input terminal represented as Tf in FIG. 8, a series binary data string (which is a waveform similar to the waveform in FIG. 7C) to be transmitted from the control circuit IC 132 is supplied. The differential output (the voltage Vcd generated between Tc and Td similar to that in FIG. 7B) of the generator 145 is transmitted to the transmission line connected to the positive-side terminal and the negative-side terminal via the capacitors 143 and 144. This voltage is the same voltage Vab generated between Ta and Tb as that in FIG. 7A.

The signal waveform shown in FIG. 7B is input to the receiver 142, and the receiver 142 outputs binary data (FIG. 7C) to the output terminal (Te) in accordance with whether the signal waveform is positive or negative. A waveform of the binary data when the power-supply voltage of the receiver 142 is +3 V is shown.

Authentication and Control Processing

By using the communication block 141 described above, two-way communication is performed between the battery pack and the main body (the charging apparatus or the application apparatus), authentication processing is performed, and control processing is performed in accordance with the authentication result. The authentication processing is repeated at predetermined intervals, for example, at intervals of 1 second by the control circuit IC 132 in the protection and authentication circuit. Furthermore, the authentication processing is performed in both the charging operation and the discharging operation.

As an authentication scheme, mutual authentication, for example, a challenge/response scheme is used. The mutual authentication is performed when the battery pack is attached to the main body. It is possible to detect whether the battery pack is attached to the main body or not by using a method of detecting the presence or absence of physical connection, for example. In the challenge/response scheme, confidential information is shared between the battery pack and the main body, and challenge data is first transmitted from the main body to the battery pack. The challenge data is temporary data, and a random number is used as the challenge data.

The battery pack which has received the challenge data generates response data from its confidential information and the challenge data, and returns the response data to the main body. The main body also performs the same generation processing, and compares the data thus generated with the response data. When the data is found to match the response data, it is recognized that the battery pack knows the confidential information. That is, the battery pack which is attached to the main body is determined to be an authorized product. Otherwise, the battery pack is not authenticated, and is determined to be an unauthorized product. The authentication result is stored.

Next, the battery pack performs authentication, and the main body is authenticated. The main body generates response data from the challenge data received from the battery pack and the confidential information, and returns the response data to the battery pack. The data generated by the same generation processing and the received response data are compared in the battery pack, authentication is performed based on whether the data matches the response data, and the authentication result is stored. In this case, the battery pack determines whether the main body is an authorized product or not.

The authentication result obtained by the battery pack is returned to the main body. In the main body, when two authentication results are successful, it is determined that the mutual authentication is successful, and the main body holds the result of the mutual authentication. When the authentication is unsuccessful, the main body is not allowed to use the battery pack. The battery pack that performs authentication holds the authentication result on the main body which is authenticated. As will be described later, when the authentication is unsuccessful, the battery pack is banned from being charged or discharged. Charging or discharging can be performed only by an authorized main body because an unauthorized main body is not authenticated by the battery pack. The authentication method of the above-described challenge/response scheme is an example of the authentication method, and other authentication methods may be used. For example, a method can also be used by which the electric cells and the main body have their own IDs, the main body performs authentication on the IDs of the electric cells, and the electric cells perform authentication on the ID of the main body.

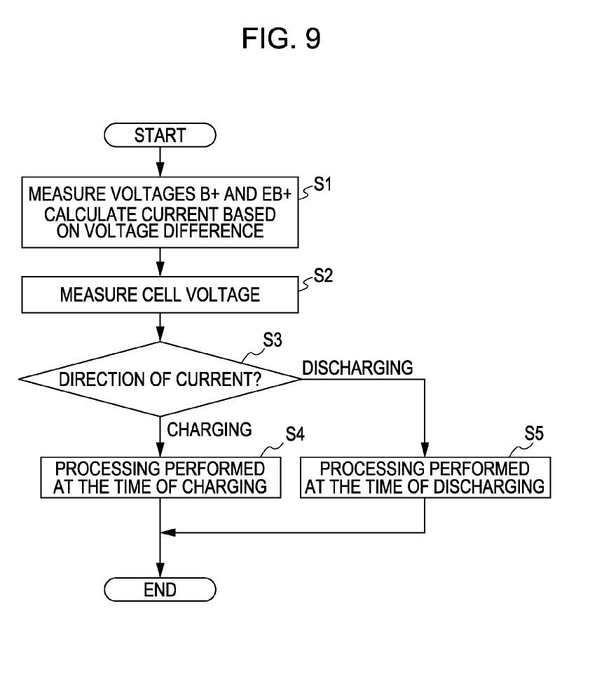

As shown in FIG. 9, when the battery pack is attached to the main body (the charging apparatus or the application apparatus), processing is started. In step S1, the voltage and current are measured. The voltage across the battery cell is represented as B+, and the voltage between the positive-side terminal and the negative-side terminal is represented as EB+. The voltage difference between these voltages is measured, and a current value is calculated based on the voltage difference. In step S2, the cell voltage is measured. When a single cell is used, the cell voltage is equal to B+.

In step S3, the direction of the current is detected, and it is determined whether the operation is a charging operation or a discharging operation based on the direction of the current. When the operation is determined to be a charging operation, step S4 (processing performed at the time of charging) is performed; when the operation is determined to be a discharging operation, step S5 (processing performed at the time of discharging) is performed.

Processing Performed at the Time of Charging

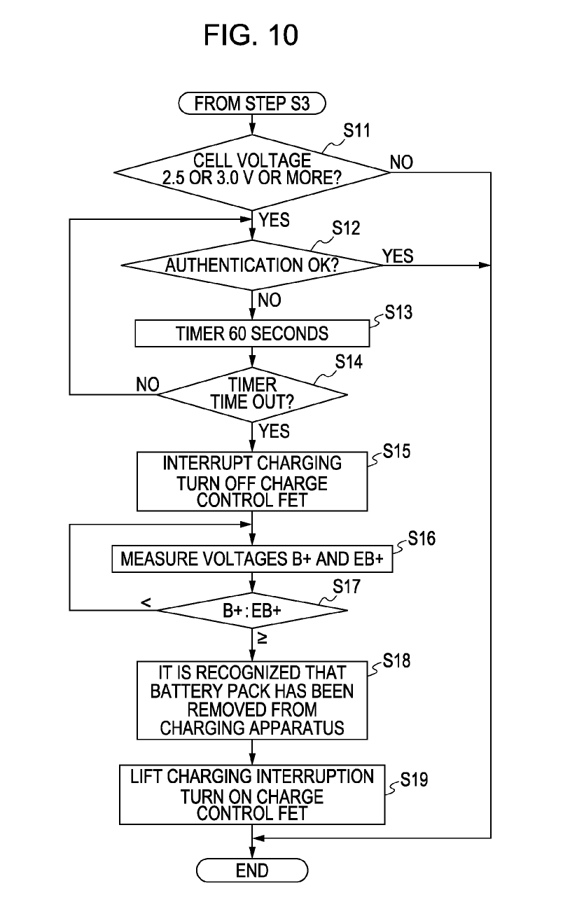

The processing performed at the time of charging (step S4 in FIG. 9) will be described with reference to FIG. 10. In step S11, it is determined whether the cell voltage measured in step S2 is 2.5 V or 3.0 V or more. To prevent overdischarge, it is checked that the battery voltage is equal to or more than a predetermined voltage. If the cell voltage is not 2.5 V or 3.0 V or more in step S11, the processing is ended.

If the cell voltage is 2.5 V or 3.0 V or more in step S11, it is determined whether authentication is successful or not in step S12. The above-described authentication processing is performed when the cell voltage is 2.5 V or 3.0 V or more in step S11. The authentication processing can be performed instead immediately after the battery pack is attached to the charging apparatus.

If authentication is successful, a charging interruption operation is not performed. If authentication is unsuccessful, a timer is set in step S13, and it is determined in step S14 whether a predetermined time, for example, 60 seconds, has elapsed or not. This waiting time guarantees that the authentication operation is performed without fail. If 60 seconds have not elapsed, the processing goes back to step S12. If it is determined that 60 seconds have elapsed, a charging interruption operation is performed in step S15. That is, the charge control FETs Q_{P}1 is turned off.

In step S16, the voltages B+ and EB+ are measured. In step S17, these voltages are compared with each other. If B+<EB+, it is determined that the battery pack is connected to the charging apparatus, and the processing goes back to step S16. If B+≧EB+, it is determined that the battery pack has been removed from the charging apparatus, and the processing proceeds to step S19. In step S19, the charging interruption operation is cancelled, and the charge control FET is turned on. As a result, the state is brought into a normal state in which both the charge control FET Q_{P}1 and the discharge control FET Q_{P}2 are turned on.

Processing Performed at the Time of Discharging

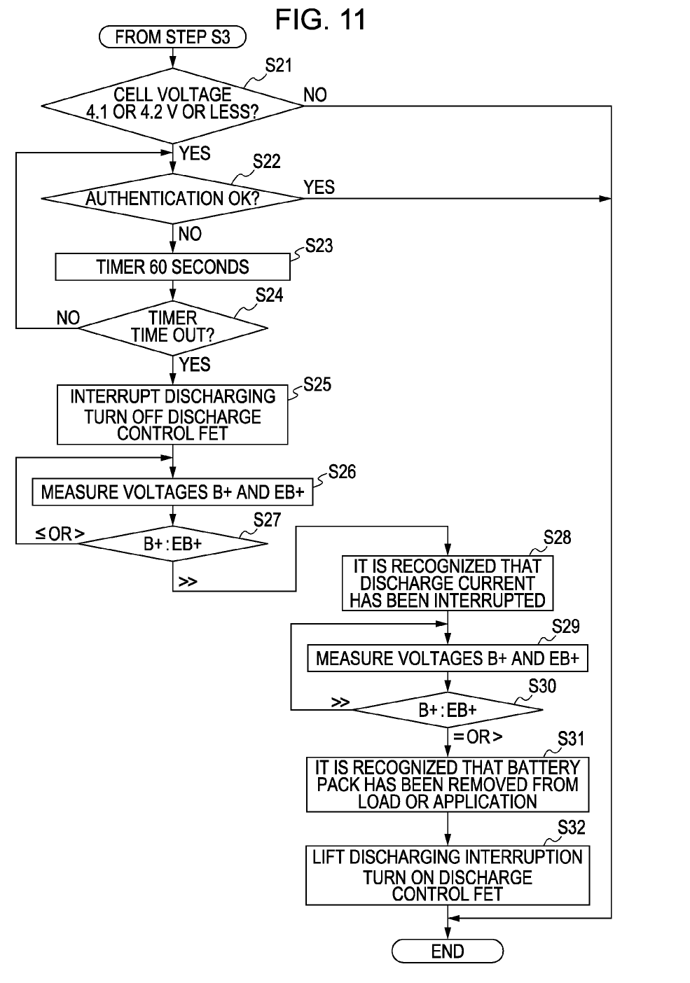

The processing performed at the time of discharging (step S5 in FIG. 9) will be described with reference to FIG. 11. In step S21, it is determined whether the cell voltage measured in step S2 is 4.1 V or 4.2 V or less. To prevent overcharge, it is checked that the battery voltage is equal to or less than a predetermined voltage. If the cell voltage is not 4.1 V or 4.2 V or less in step S21, the processing is ended.

If the cell voltage is 4.1 V or 4.2 V or less in step S21, it is determined in step S22 whether authentication is successful or not. The above-described authentication processing is performed when the voltage is 4.1 V or 4.2 V or less in step S21. The authentication processing can be performed instead immediately after the battery pack is attached to the main body.

If authentication is successful, discharging interruption operation is not performed. If authentication is unsuccessful, a timer is set in step S23, and it is determined whether a predetermined time, for example, 60 seconds, has elapsed or not in step S24. This waiting time guarantees that the authentication operation is performed without fail. If 60 seconds have not elapsed, the processing goes back to step S22. If it is determined that 60 seconds have elapsed, a discharging interruption operation is performed in step S25. That is, the discharge control FET Q_{P}2 is turned off.

In step S26, the voltages B+ and EB+ are measured. In step S27, these voltages are compared with each other. If B+>EB+ or B+EB+, it is determined that the discharging current is not interrupted, and the processing goes back to step S26. If B+>>EB+, that is, if B+ is sufficiently greater than EB+, it is recognized in step S28 that the discharging current has been interrupted, and the processing proceeds to step S29.

In step S29, the voltage B+ and EB+ are measured. In step S30, these voltages are compared with each other. If B+>>EB+, it is determined that the battery pack is connected to the main body, and the processing goes back to step S29. If B+=EB+ or B+>EB+, it is determined in step S31 that the battery pack has been removed from the main body, and the processing proceeds to step S32. In step S32, the discharging interruption operation is cancelled, and the discharge control FET is turned on. As a result, the state is brought into a normal state in which both the charge control FET Q_{P}1 and the discharge control FET Q_{P}2 are turned on.

A Battery Pack Having Electric Cells

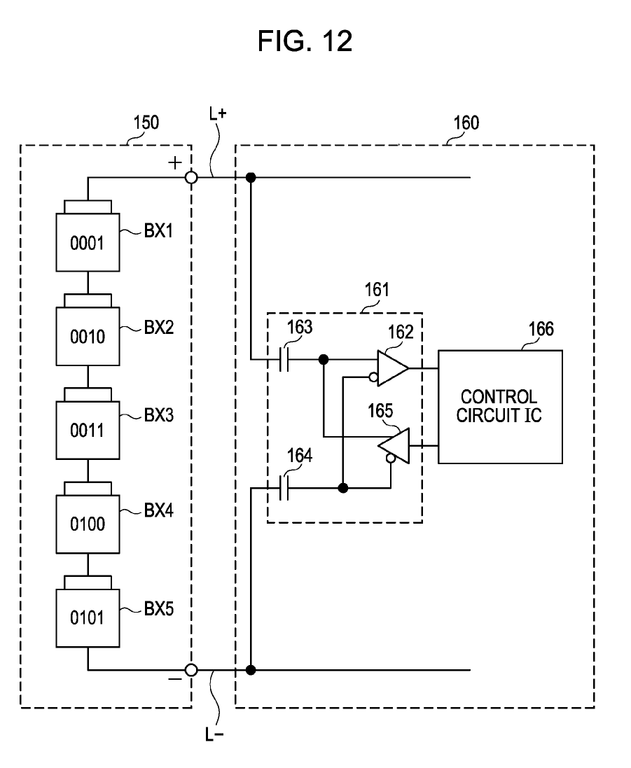

The embodiment is a battery pack in which a plurality of, for example, five cylindrical lithium-ion secondary batteries (electric cells) described above are connected in series. Each electric cell includes the protection and authentication circuit shown in FIG. 5. Therefore, there is no necessity to draw a conductor for measuring the voltage and current out of each electric cell, and this simplifies the structure of the battery pack. As shown in FIG. 12, a plurality of electric cells BX1, BX2, BX3, BX4, and BX5 are connected in series, whereby a battery pack 150 is formed. At the positive-side terminal and the negative-side terminal of the battery pack 150, an output voltage of 4.2 V×5=21 V is generated.

The battery pack 150 and a main body (a charging apparatus or a application apparatus) 160 are connected by lines L+ and L−. As described above, a battery voltage and a series binary data string superimposed on the battery voltage are transmitted to the main body 160 via the lines L+ and L−. A communication block 161 of the main body 160 has the same configuration as the communication block (see FIGS. 5 to 8) of each of the electric cells BX1 to BX5. That is, the communication block 161 has a receiver 162 which receives a data string from the battery pack 150 via capacitors 163 and 164 and a generator 165 which sends a data string to the battery pack 150 via the capacitors 163 and 164.

The communication block 161 is connected to a control circuit IC 166. The control circuit IC 166 controls communication between the main body 160 and the battery pack 150, and controls the authentication processing between the main body 160 and the battery pack 150. An address is assigned to each electric cell of the battery pack 150. For example, an address of 4 bits is assigned. The address is stored in a nonvolatile memory in the control circuit IC 132 of each electric cell. At the time of assembly of the battery pack, the addresses by which the electric cells housed in the same battery pack can be identified are written into the nonvolatile memories in the control circuit ICs 132 of the electric cells.

As an example, an address (0001) is assigned to the electric cell BX1, and addresses (0010), (0011), and (0100) are assigned to the electric cells BX2, BX3, and BX4, respectively. Since the address is assigned in this way, it is possible to perform two-way communication individually for each electric cell in communication via the two lines L+ and L−.

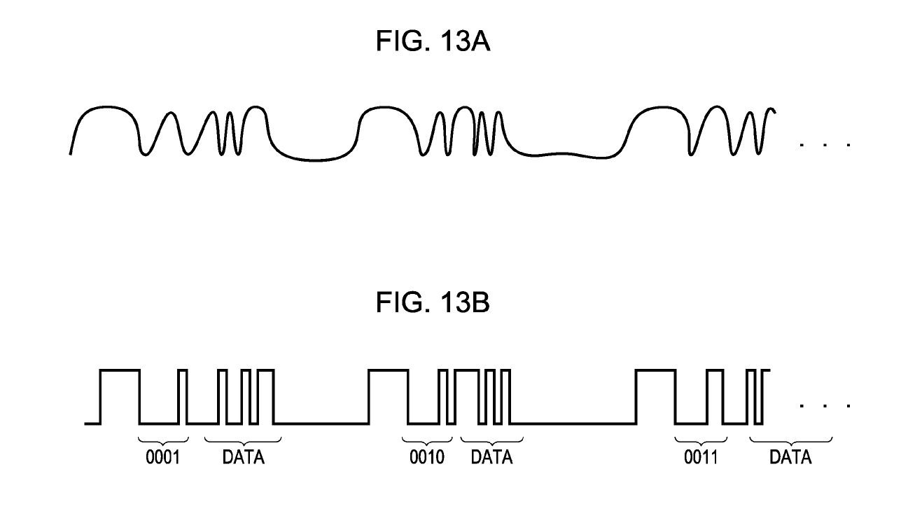

For example, when the control circuit IC 166 specifies the address (0001) of the electric cell BX1 and transmits data to the battery pack 150, only the electric cell BX1 generates data, and transmits the generated data to the communication block 161 of the main body 160. As shown in FIG. 13A, the data which is sent from the battery pack 150 and has the address of each electric cell at the head thereof is received by the communication block 161 of the main body 160, and a binary data string shown in FIG. 13B is supplied to the control circuit IC 166.

As described above, since communication can be performed individually with the electric cells of the battery pack 150, authentication can also be performed on each electric cell. Therefore, it is possible to interrupt charging or discharging when one of the electric cells BX1 to BX5 is an unauthorized product.

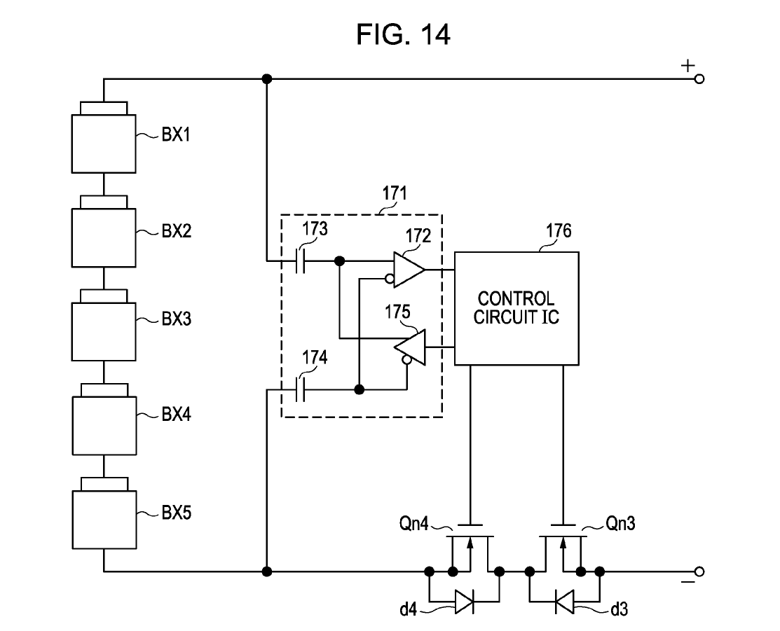

As shown in FIG. 14, in addition to a plurality of electric cells BX1 to BX5, a communication block 171, a control circuit IC 176, a charge control FET Qn3, and a discharge control FET Qn4 may be provided in the battery pack. Parasitic diodes d3 and d4 are present between the drains and sources of the FETs. Since the charge control FET Qn3 and the discharge control FET Qn4 are provided outside the electric cell, it is possible to use the N-channel FET. The configuration of the main body is the same as the example shown in FIG. 12.

The communication block 171 performs communication with each electric cell in the battery pack, and individual information of each electric cell is supplied to the control circuit IC 176. The control circuit IC 176 detects overcharge or overdischarge of each electric cell based on the input individual information. When overcharge occurs, the charge control FET Qn3 is turned off; when overdischarge occurs, the discharge control FET Qn4 is turned off. In a single parallel circuit configuration as shown in FIG. 14, it is possible to omit the charge control FET and the discharge control FET in each electric cell. However, in a multiple parallel circuit configuration, since there is a possibility that, even one circuit is interrupted, another parallel circuit is charged and discharged, it is difficult to omit the charge control FET and the discharge control FET in each electric cell.

Authentication Performed on a Battery Pack with Electric Cells

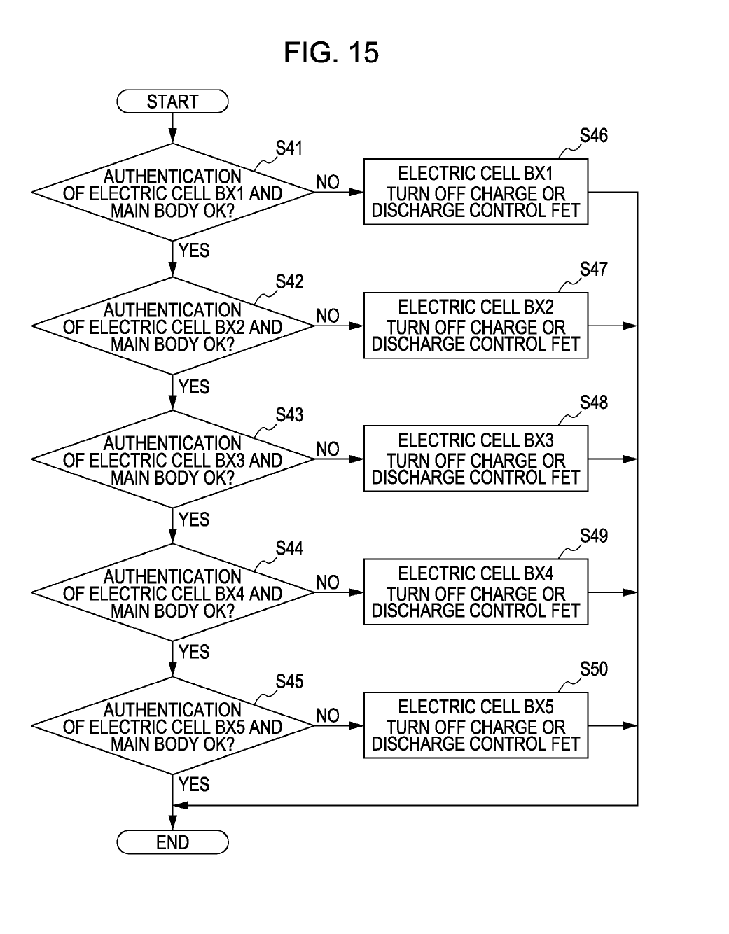

As shown in a flow chart of FIG. 15, authentication processing is performed on the battery pack 150 having a plurality of electric cells BX1 to BX5. In step S41, authentication processing of the electric cell BX1 and the main body 160 is performed. If authentication is successful, the processing proceeds to step S42, and authentication processing of the electric cell BX2 and the main body 160 is performed. If authentication is unsuccessful, the charge control FET or the discharge control FET is turned off in the electric cell BX1 in step S46. Then, the processing is ended. If authentication of the electric cell BX2 and the main body 160 is unsuccessful in step S42, the charge control FET or the discharge control FET is turned off in the electric cell BX2 in step S47, and the processing is ended.

Subsequently, the result of the authentication processing of the electric cell BX3 and the main body 160 (step S43), the result of the authentication processing of the electric cell BX4 and the main body 160 (step S44), and the result of the authentication processing of the electric cell BX5 and the main body 160 (step S45) are determined. If the authentication is determined to be unsuccessful in the result of the authentication processing, the control FET or the discharge control FET of a corresponding electric cell is turned off (steps S48, S49, and S50), and the processing is ended.

### 3. Modified Example

Although an embodiment has been specifically described, the present application is not limited to the above-described embodiment, and many modifications and variations are possible based on the technical idea of the present application. For example, the protection and authentication circuit of each electric cell may have an authentication function alone, and, as shown in FIG. 14, separate protection circuits may be provided or a switching element may be provided in the main body. For example, when the battery pack is used as a power source of an electric tool, it is sometimes difficult to incorporate an FET for a high current in the battery pack. Furthermore, connection of a plurality of electric cells may parallel connection or serial-parallel connection in addition to serial connection.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

1. A battery pack, comprising:
a plurality of electric cells connected in series or in parallel between first and second lines,
each of the electric cells including a battery cell, a control circuit which performs authentication processing, a communication block which is connected to the control circuit and superimposes a series binary data string on a battery output of the battery cell, and a switching element controlled by the control circuit, wherein
the control circuit generates an address thereof,
the control circuit of each electric cell performs authentication on each electric cell by transmitting the series binary data string including the address to a main body via the communication block and the first and second lines,
the switching element is turned on when the authentication is successful and charging or discharging is performed, and
the switching element is turned off when the authentication is unsuccessful and charging or discharging is banned.

2. The battery pack according to claim 1, wherein the control circuit of each electric cell further controls an overcharge protective function and an overdischarge protective function of the battery cell.

3. The battery pack according to claim 1, further comprising a control circuit communicating with the control circuit of each electric cell and controlling an overcharge protective function and an overdischarge protective function of the battery cell included in each electric cell.

4. The battery pack according to claim 1,
wherein each of the electric cells further includes
a housing having a cylindrical form closed at one end face thereof, containing a power-generating element, being made of metal material and connected to a negative electrode side of the power-generating element,
a safety valve device at the other end face of the housing, closing the other end face of the housing, and
a battery lid having a plurality of foot portions and being made of metal material and located above the safety valve device,
wherein the safety valve device has a plate-like safety valve which is made of metal material and is deformed by an increase in a battery internal pressure and an interrupting section interrupting electrical connection between a positive electrode side of the power-generating element and the battery lid by the deformation of the safety valve,
wherein a printed wiring board having an opening at the center thereof is placed between the safety valve and the battery lid,
wherein the switching element is formed of a P-channel FET on the printed wiring board, the P-channel FET switching a current path between the safety valve and the battery lid, and
wherein a grounding side of the control circuit is connected to the housing.

5. The battery pack according to claim 4, wherein part of an upper edge of the housing extends to the grounding side of the control circuit.

6. The battery pack according to claim 4, wherein the P-channel FET and the control circuit are mounted on an upper face of the printed wiring board in a position corresponding to an opening between the foot portions of the battery lid.

7. The battery pack according to claim 4, wherein a fuse is inserted in series with the current path and is mounted on the printed wiring board.

8. The battery pack according to claim 7, wherein one end of the fuse is connected to the P-channel FET, and the other end thereof is connected to a flange portion of the battery lid via a conductive pattern.

9. The battery pack according to claim 4, wherein a coating material sealing an area near the P-channel FET and a fuse which are mounted on the printed wiring board and a coating material sealing an area near the control circuit are provided.

10. The battery pack according to claim 4, wherein, as the P-channel FET provided in the electric cell, an FET for charge control and an FET for discharge control are provided.

11. The battery pack according to claim 10, wherein
the positive electrode side of the power-generating element is connected to a source of the FET for charge control, and a drain of the FET for charge control is connected to a drain of the FET for discharge control, and
a source of the FET for discharge control is connected to a positive-side terminal via a fuse.

12. The battery pack according to claim 11, wherein
the control circuit supplies a charge control signal to a gate of the FET for charge control via a resistor, and
the control circuit supplies a discharge control signal to a gate of the FET for discharge control via a resistor.

13. The battery pack according to claim 4, wherein a power supply terminal of the control circuit is connected to a positive electrode side of the electric cell and a source of an FET for discharge control, and a grounding terminal of the control circuit is connected to a negative electrode side of the electric cell.
